(19) United States
(12) Patent Application Publication
(10) Pub. No.: US 2013/0254380 A1
(43) Pub. Date: Sep. 26, 2013

(54) COMPUTER SYSTEM COMPRISING A PLURALITY OF SERVERS

(71) Applicants: KANG WU, Shenzhen City (CN); BO TIAN, Shenzhen City (CN)

(72) Inventors: KANG WU, Shenzhen City (CN); BO TIAN, Shenzhen City (CN)

(21) Appl. No.: 13/659,998

(22) Filed: Oct. 25, 2012

(30) Foreign Application Priority Data
Mar. 22, 2012 (CN) 201210077818.4

(51) Int. Cl. G06F 15/173

(52) U.S. Cl. 709/224

(57) ABSTRACT

A computer system includes a plurality of servers, a connection unit, and a control unit. Each of the plurality of servers generates feedback signals, a first type of control signals, and high-speed signals. The control unit includes an integrated baseboard management controller (IBMC) and a strobe circuit, and the IBMC generates a second type of control signals. Each of the plurality of servers is electrically connected to the control unit via the connection unit. The feedback signals and the first type of control signals generated by each of the plurality servers are transmitted to the IBMC via the connection unit. The second type of control signals are transmitted to each of the plurality of servers via the connection unit, and the strobe circuit selectively transmits the high-speed signals generated by one of the plurality of servers to the IBMC.

### BACKGROUND

1. Technical Field

The present disclosure relates to computer systems, and particularly to a computer system comprising a plurality of servers.

2. Description of Related Art

A computer system can employ a plurality of servers to enhance data processing capability. For example, a common four-in-one server system includes four servers. The four servers share one hard disk backboard electrically connected to hard disk drives. In use, each of the four servers can control a plurality of hard disk drives via the hard disk backboard, so that the four-in-one server system achieves high data processing capability.

In a computer system employing a plurality of servers, the servers generally require to be capable of working independently from each other to prevent failures of any one of the servers from adversely affecting the other servers. Therefore, each of the servers may need an integrated baseboard management controller (IBMC), and the IBMC of each of the servers should be independent from the IBMCs of the other servers. However, equipping an exclusive IBMC for each of the servers may be costly and complicates a hardware structure of the computer system.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a computer system, according to an exemplary embodiment.

FIG. 2 is a circuit diagram of the computer system shown in FIG. 1.

### DETAILED DESCRIPTION

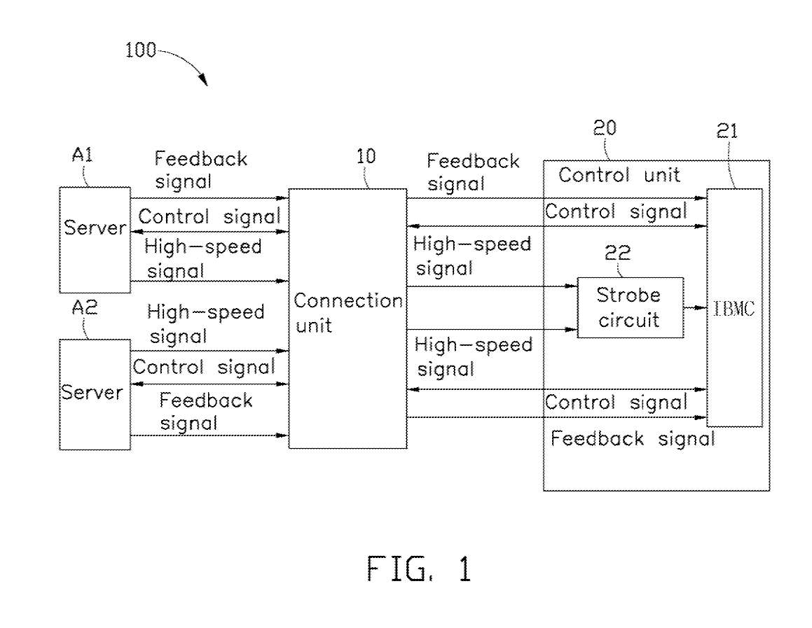

FIG. 1 is a block diagram of a computer system 100, according to an exemplary embodiment. The computer system 100 includes at least two servers A1 and A2, a connection unit 10, and a control unit 20. The at least two servers A1 and A2 can work independently from each other. The connection board 10 can be a bridging board. The control unit 20 includes an integrated baseboard management controller (IBMC) 21. Both the at least two servers A1 and A2 are electrically connected to the IBMC 21 via the connection unit 10, and share the IBMC 21.

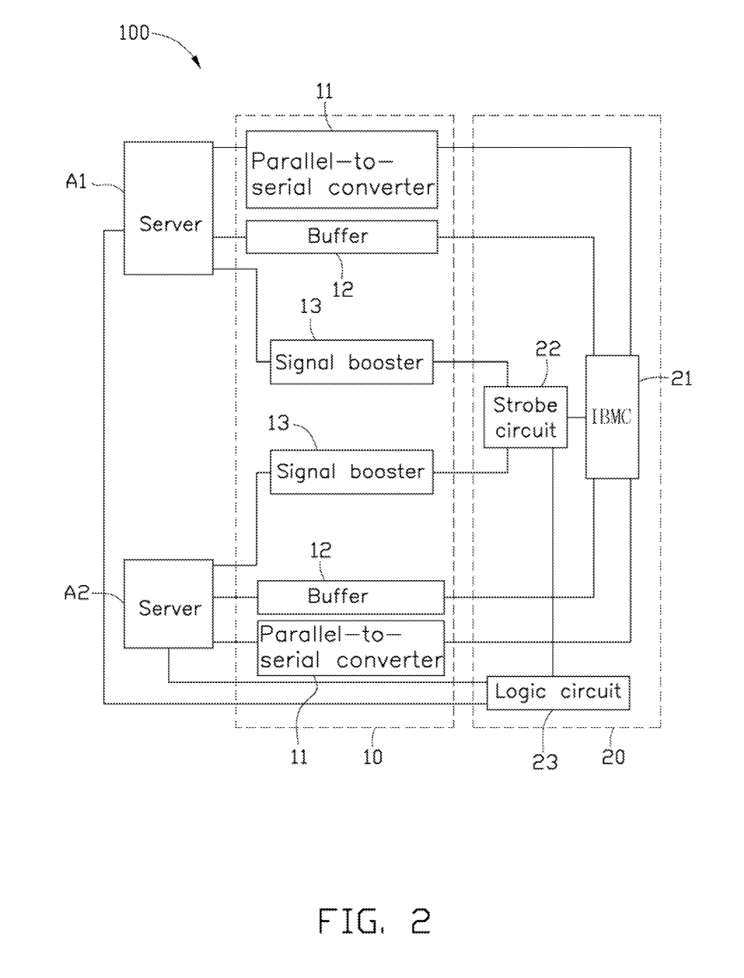

Also referring to FIG. 2, the connection unit 10 includes at least two parallel-to-serial converters 11, at least two buffers 12, and at least two signal boosters 13, which correspond to the at least two servers A1 and A2. The control unit 20 further includes a strobe circuit 22 electrically connected to the IBMC 21. Each of the servers A1 and A2 is electrically connected to a corresponding one of the parallel-to-serial converters 11, a corresponding one of the buffers 12, and a corresponding one of the signal boosters 13. Both the at least two parallel-to-serial converters 11 and both the at least two buffers 12 are electrically connected to the IBMC 21. Both the at least two signal boosters 13 are electrically connected to the strobe circuit 22.

In most computer systems, electronic signals transmitted between a server and an IBMC of the server include control signals, feedback signals, and high-speed signals. The control signals may be generated by the server and transmitted from the server to the IBMC, and may be generated by the IBMC and transmitted from the IBMC to the server. The feedback signals and the high-speed signals can only be transmitted from the server to the IBMC. Generally, an IBMC is capable of simultaneously receiving and processing the feedback signals of a plurality of servers, and is also capable of simultaneously communicating with a plurality of servers using the control signals, but is difficult to simultaneously receive and process the high-speed signals of a plurality of servers. Accordingly, in this embodiment, a particular method for electrically connecting the servers A1 and A2 with the control unit 20 via the connection unit 10 is detailed as follows.

As shown in FIG. 1, feedback signals sent from each of the servers A1 and A2 are transmitted to the parallel-to-serial converter 11 corresponding to the server A1/A2. The parallel-to-serial converter 11 converts the feedback signals to serial signals, such as system management bus (SMBus) signals, and delivers the serial signals to the IBMC 21. The IBMC 21 can determine a working status of the server A1/A2 according to the serial signals. In this way, transmission of the feedback signals does not need complicated hardware, and calculation for determining the working status of the server A1/A2 can be simplified.

Both a first type of control signals sent from each of the servers A1 and A2 to the IBMC 21 and a second type of control signals sent from the IBMC 21 to the server A1/A2 are transmitted via the buffer 12 corresponding to the server A1/A2. In this way, the control signals can be buffered by the buffer 12 before they are received by the IBMC 21 and/or the server A1/A2, so that the control signals received by the IBMC 21 and/or the server A1/A2 can have high stability and precision.

High-speed signals sent from each of the servers A1 and A2 are transmitted to the signal booster 13 corresponding to the server A1/A2. The signal booster 13 boosts the high-speed signals to improve quality (e.g., stability and precision) of the high-speed signals, and delivers the boosted high-speed signals to the strobe circuit 23. The strobe circuit 23 can selectively deliver high-speed signals sent from any one of the servers A1 and A2 to the IBMC 21. In this way, when the servers A1 and A2 simultaneously output high-speed signals, the strobe circuit 23 can prevent both the high-speed signals sent from the server A1 and the high-speed signals sent from the server A2 from being simultaneously received by the IBMC 21. Thus, the high-speed signals sent from the server A1 and the high-speed signals sent from the server A2 are prevented from interfering with each other and causing failures of the IBMC 21. According to the above-described method, the at least two servers A1 and A2 can share the IBMC 21, without interfering with each other.

Also referring to FIG. 2, the control unit 20 further includes a logic circuit 23. Both of the at least two servers A1 and A2 are electrically connected to the strobe circuit 22 via the logic circuit 23. When each of the at least two servers A1 and A2 is actuated, the server A1/A2 generates a connection request signal and sends the connection request signal to the logic circuit 23. The logic circuit 23 generates selection signals according to the connection request signals sent from the at least two servers A1 and A2, and sends the selection signals to the strobe circuit 22. Upon receiving the selection signals, the strobe circuit 22 selectively delivers the high-speed signals sent from one of the at least two servers A1 and A2 to the IBMC 21 according to the selection signals. In this way, the high-speed signals sent from the server A1 and the high-speed signals sent from the server A2 are prevented from being simultaneously received by the IBMC 21.

In this embodiment, if only one of the at least two servers A1 and A2 is actuated and sends the connection request signal to the logic circuit 23, the logic circuit 23 directly generates a selection signal corresponding to the actuated server A1/A2, and sends the selection signal to the strobe circuit 22. Upon receiving the selection signal, the strobe circuit 22 delivers the high-speed signals sent from the actuated server A1/A2 to the IBMC 21. If both the at least two servers A1 and A2 are actuated and simultaneously send their connection request signals to the logic circuit 23, the logic circuit 23 generates a selection signal corresponding to a selected one of the at least two servers A1 and A2 according to a predetermined priority, and sends the selection signal to the strobe circuit 22. Upon receiving the selection signal, the strobe circuit 22 delivers the high-speed signals sent from the selected server A1/A2 to the IBMC 21. The priority of selecting one of the at least two servers A1 and A2 and delivering the high-speed signals sent from the selected server A1/A2 to the IBMC 21 can be changed at any time.

In other embodiments, the computer system 100 can further include more than two servers that are similar to the severs A1 and A2. The connection unit 10 can include more than two parallel-to-serial converters 11, more than two buffers 12, and more than two signal boosters 13 corresponding to these servers. Each of the servers is electrically connected to the BMC 21 via a corresponding parallel-to-serial converter 11 and a corresponding buffer 12, and is electrically connected to the strobe circuit 22 via a corresponding signal booster 13 and the logic circuit 23. Methods for using these embodiments are substantially similar to the above-described method.

The computer system 100 enables a plurality of servers (e.g., the at least two servers A1 and A2) to share a same IBMC (e.g., the IBMC 21), without interfering with each other. Therefore, the computer system 100 does not need to equip an exclusive IBMC for each of the plurality of servers. Thus, cost of the computer system 100 can be conserved, and a hardware structure of the computer system 100 can be simplified.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A computer system, comprising:
a plurality of servers, each of the plurality of servers generating feedback signals, a first type of control signals, and high-speed signals;
a connection unit; and
a control unit including an integrated baseboard management controller (IBMC) and a strobe circuit electrically connected to the IBMC, the IBMC generating a second type of control signals;
wherein each of the plurality of servers is electrically connected to the control unit via the connection unit, the feedback signals and the first type of control signals generated by each of the plurality servers are transmitted to the IBMC via the connection unit, the second type of control signals are transmitted to each of the plurality of servers via the connection unit, and the strobe circuit selectively transmits the high-speed signals generated by one of the plurality of servers to the IBMC.

2. The computer system of claim 1, wherein the connection unit includes a plurality of parallel-to-serial converters corresponding to the plurality of servers, the feedback signals generated by each of the plurality of servers is converted to serial signals by the parallel-to-serial converters corresponding to the server, and the serial signals is delivered to the IBMC.

3. The computer system of claim 2, wherein the serial signals are system management bus (SMBus) signals.

4. The computer system of claim 1, wherein the connection unit includes a plurality of buffers corresponding to the plurality of servers, the first type of control signals generated by each of the plurality of servers are transmitted to the IBMC via the buffer corresponding to the server, and the second type of control signals are transmitted to each of the plurality of servers by the buffer.

5. The computer system of claim 1, wherein the connection unit includes a plurality of signal boosters corresponding to the plurality of servers, and each of the signal boosters is electrically connected to the strobe circuit; the high-speed signals generated by each of the plurality of servers is boosted by the parallel-to-serial converters corresponding to the server, and the boosted signals is delivered to the strobe circuit.

6. The computer system of claim 5, wherein the control unit further includes a logic circuit, and each of the plurality of servers is electrically connected to the strobe via the logic circuit; when the plurality of servers send connection request signals to the logic circuit, the logic circuit controls the strobe circuit to selectively transmit the high-speed signals sent from one of the plurality of servers to the IBMC according to the connection request signals.

7. The computer system of claim 6, wherein when only one of the plurality of servers sends the connection request signal to the logic circuit, the logic circuit directly controls the strobe circuit to transmit the high-speed signals of the server sending the connection request signal to the IBMC.

8. The computer system of claim 7, wherein when at least two of the plurality of servers simultaneously send the connection request signals to the logic circuit, the logic circuit controls the strobe circuit to transmit the high-speed signals of a selected one of the at least two servers to the IBMC according to a predetermined priority.
